(19) United States
(12) Patent Application Publication
(10) Pub. No.: US 2024/0146661 A1
(43) Pub. Date: May 2, 2024

(54) METHODS AND APPARATUS FOR EXTENDED REALITY ENHANCEMENT IN MOBILE COMMUNICATIONS

(71) Applicant: MediaTek Singapore Pte. Ltd., Singapore (SG)

(72) Inventors: Abdellatif SALAH, Cambridge (GB); Chien-Chun HUANG-FU, Hsinchu City (TW); Chi-Hsuan HSIEH, Hsinchu City (TW); Wei-De WU, Hsinchu City (TW)

(21) Appl. No.: 18/547,217

(22) PCT Filed: Mar. 7, 2022
(86) PCT No.: PCT/CN2022/079469

§ 371 Date: Aug. 21, 2023

Related U.S. Application Data
(60) Provisional application No. 63/158,393, filed on Mar. 9, 2021.

(51) Int. Cl. H04L 47/2416; G06F 3/01; H04L 47/43; H04L 65/80

(52) U.S. Cl. CPC H04L 47/2416; G06F 3/011; H04L 47/43; H04L 65/80

(57) ABSTRACT

Various solutions for extended reality (XR) enhancement in mobile communications are described. An apparatus establishes a communication with a network node of a wireless network. The apparatus performs an operation with respect to XR-related computation offloading from a user end to result in XR enhancement at the user end.

### CROSS REFERENCE TO RELATED PATENT APPLICATION(S)

The present disclosure is part of a non-provisional application claiming the priority benefit of U.S. Patent Application No. 63/158,393, filed 9 Mar. 2021, the content of which being incorporated by reference in its entirety.

### TECHNICAL FIELD

The present disclosure is generally related to mobile communications and, more particularly, to techniques for extended reality (XR) enhancement in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), further enhancements are required to ensure 5G support of latency-sensitive throughput-sensitive applications. One emerging trend is the rise of 5G applications for XR, which includes virtual reality (VR), augmented reality (AR) and mixed reality (MR). Coordination and sharing of information between an XR server, multi-access edge computing (MEC) and a radio access network (RAN) is required to further optimize end-to-end (E2E) performance including throughput, latency and reliability. Therefore, there is a need for a solution of XR enhancement in mobile communications in order to meet such requirements.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for XR enhancement in mobile communications. It is believed that various schemes proposed herein may further optimize E2E performance with respect to XR enhancement including improvement in throughput, latency and reliability in support of latency-sensitive throughput-sensitive applications.

In one aspect, a method may involve establishing a communication with a network node of a wireless network. The method may also involve performing an operation with respect to XR-related computation offloading from a user end to result in XR enhancement at the user end.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-vehicle (V2V), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to XR enhancement in mobile communications. According to the present disclosure, a number of possible solutions may be implemented separately or jointly. That is, although these possible solutions may be described below separately, two or more of these possible solutions may be implemented in one combination or another.

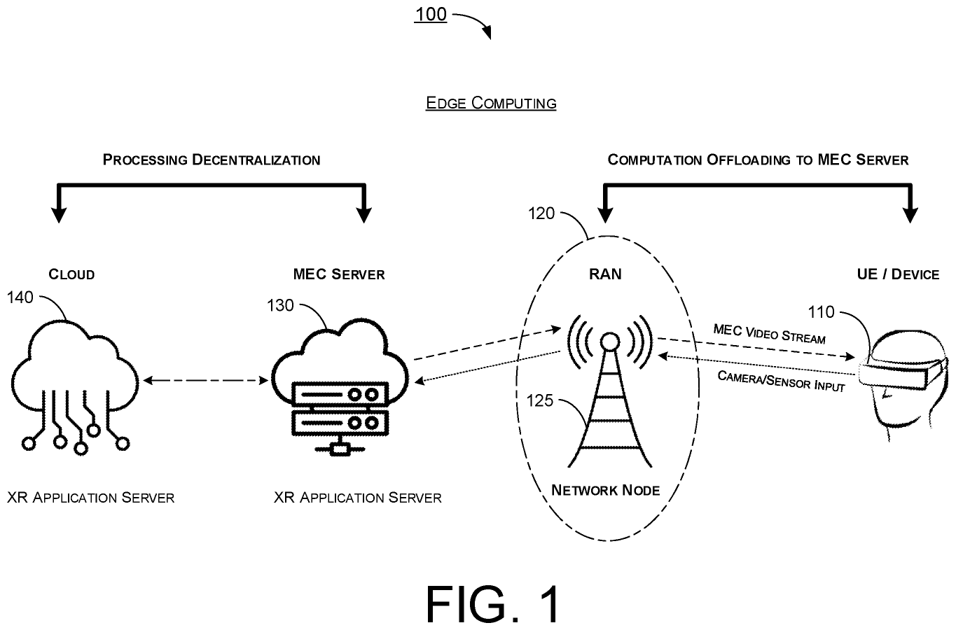

FIG. 1 illustrates an example network environment 100 in which various solutions and schemes in accordance with the present disclosure may be implemented. Referring to FIG. 1, network environment 100 may involve a device or user equipment (UE) 110 (e.g., a VR/AR/MR headset worn by a user) in wireless communication with a RAN 120 (e.g., a 5G NR mobile network and/or another type of network such as a LTE network, a LTE-Advance network, a NB-IoT network, an IoT network, an IIoT network and/or an NTN), which is in communication with a network including a MEC server 130 and a cloud 140 (e.g., a remote cloud). UE 110 may be in wireless communication with RAN 120 via a base station or network node 125 (e.g., an eNB, gNB or transmit-receive point (TRP)). Each of MEC server 130 and cloud 140 may include or otherwise function as an XR application server (herein interchangeably referred to as “XR server”). Moreover, MEC server 130 may function as an Edge cloud while cloud 140 may function as a remote cloud or slave Edge cloud.

It is believed that wireless XR/VR would eliminate geographical or behavioral restrictions on the user and allow XR/VR users much greater freedom of movement. Moreover, wireless XR/VR is projected to unleash or otherwise enable a wide range of applications in gaming, simulation, education and commerce. In the context of XR or VR, motion-to-photon latency refers to the required time for user movement of a user of UE 110 to be reflected on a screen of UE 110. For example, in case the user moves his/her head to look in a different direction and it takes 30 ms to reflect the head movement in the screen of UE 110 (e.g., a VR device) to update the view displayed on the screen, then the 30 ms is considered the motion-to-photon latency. Thus, low motion-to-photon latency (e.g., less than 15-20 ms) is necessary to convince the eyes and brain of the user of his/her real presence in the displayed scene. As such, computation offloading to MEC server 130 by UE 110 (and RAN 120) may be carried out as a way to minimize the motion-to-photon latency. To further minimize the latency, MEC server 130 may also decentralize processing on its part to cloud 140. In network environment 100, UE 110, RAN 120 (e.g., network node 125) and MEC server 130 may implement respective aspects of various schemes proposed herein pertaining to XR enhancement in mobile communications, as described below.

Under a first proposed scheme in accordance with the present disclosure, information and/or data transmitted in transport blocks, frames and/or packets (e.g., XR-related packets) across one or more layers between an XR application server (e.g., MEC server 130) and a RAN (e.g., RAN 120 via network node 125), such as data packets from the XR application server to RAN, may be labeled with delay-related information (e.g., delay information such as an amount of remaining/consumed delay or delay budget) to assist and optimize RAN scheduling. In a first option (Option 1), every packet may be independently labeled with its own remaining (or residual) delay after each processing block and/or after each transmission layer. Hence, a delay budget (which is an amount of time remaining for delay) may be decremented after each step in the transmission. In a second option (Option 2), every packet may be independently labeled with its own consumed delay incremented after each processing block and/or after each transmission layer. In a third option (Option 3), every packet may be labeled with a respective priority level corresponding to a respective amount of remaining or consumed delay. It is noteworthy that jitter value for each packet may be included in the delay calculation during labeling.

Accordingly, under the first proposed scheme, two packets having the same quality of service (QoS) characteristics may be allocated to two different QoS flows or treated differently for RAN scheduling or at UE processing because of their two different remaining latency budgets. For instance, a first packet and a second packet may have the same packet delay budget of 20 ms for E2E transmission. The first packet may have consumed 7 ms in video rendering at MEC server 130, thus having a remaining delay budget of 13 ms. The second packet may have consumed 5 ms in video rendering at MEC server 130, thus having a remaining delay budget of 15 ms. It is believed that this proposed scheme may address the jitter issue for the same QoS flow.

Moreover, from a physical (PHY) layer perspective, higher layers do not have visibility about the remaining or residual packet delay budget. The first proposed scheme would provide visibility to higher layers about the time consumed per packet for radio transmissions. For instance, a packet which is successful after multiple hybrid automatic repeat request (HARQ) retransmissions at PHY may have consumed more time than a packet which is successful straight away. Hence, a delay labeling may be useful across layers to possibly priority packets with close-to expiry delay budget. It is believed that this proposed scheme may address the jitter issue for the same QoS flow.

Under the first proposed scheme, at the XR server side (e.g., MEC server 130), computation (or processing) offloading may be based on the labeled delay information. For instance, one or more packets with a smaller remaining delay budget may be processed at an Edge cloud or Edge server, while one or more other packets with a larger remaining delay budget may be processed at a remote cloud (or remote server) or another slave Edge cloud.

Under the first proposed scheme, packet handling when the delay budget is over may be handled accordingly. For instance, the packet may be dropped in a particular layer (e.g., its current layer and/or the PHY layer). Alternatively, or additionally, the priority of the packet may be adjusted (e.g., by prioritizing or deprioritizing the packet).

Under the first proposed scheme, a delay budget for new packets in scenarios of packet segmentation and/or concatenation may be provided. For instance, for packet segmentation, new packets may share the same remaining or residual delay budget. Alternatively, or additionally, for packet concatenation, new packets may use the lowest, highest, average or medium delay budget of the original packets.

Under a second proposed scheme in accordance with the present disclosure, XR server awareness about RAN performance may be useful in optimizing video encoding based on RAN performance and capacity. Under the second proposed scheme, QoS metrics characterizing the RAN operation of RAN 120 may be communicated to an XR server (e.g., MEC server 130) and may be useful to optimize video coding/decoding (codec) adaptation by MEC server 130. For instance, RAN 120 may recommend the bit rates and/or latency and/or reliability supported by RAN 120 at a specific time, and such information may be utilized by MEC server 130 in performing video encoding/decoding.

Under the second proposed scheme, RAN 120 may signal mobility event to MEC server 130 for QoS flow and encoding/rendering adjustment and codec adaptation. For instance, RAN 120 may signal to MEC server 130 about handover events (e.g., handover of UE 110 between from one cell to another cell of RAN 120). Alternatively, or additionally, RAN 120 may signal to MEC server 130 about handover completion (e.g., so that codec may be resumed and/or upgraded by MEC server 130).

Under the second proposed scheme, RAN 120 may signal prediction about mobility event(s) and/or traffic-related event(s) to MEC server 130 for QoS flow and encoding/rendering adjustment and codec adaptation. For instance, RAN 120 may signal to MEC server 130 about potential handovers. Alternatively, or additionally, RAN 120 may signal to MEC server 130 about potential user plane congestion.

Under the second proposed scheme, QoS metrics characterizing MEC server 130 (e.g., latency, jitter and other parameters) may be communicated to RAN to optimize RAN scheduling and processing. For instance, statistics such as a charging data function (CDF) about MEC server 130 processing (delay and jitter) may be communicated to the RAN.

Under the second proposed scheme, RAN 120 may signal information about events impacting its performance to MEC server 130. For instance, RAN 120 may signal to MEC server 130 about channel degradation, beam blockage and/or interference. Alternatively, or additionally, RAN 120 may signal to MEC server 130 about bandwidth part (BWP) switching.

Under a third proposed scheme in accordance with the present disclosure, distribution of MEC tasks may be assisted by RAN 120. To reduce power consumption and improve form factor, a VR/AR terminal may offload the processing to the cloud. However, offloading to a remote cloud may result in latency. Hence, relying on an Edge cloud may be desirable from latency perspective. Nevertheless, offloading may also result in reliance on RAN 120 network for transmission which may not be a stable link and may change with the change of wireless environment as well as the uncertainty of channel conditions, which may be impacted by interference. Thus, rendering at a VR/AR device may be safer from reliability perspective. On the other hand, some lower-priority traffic and/or less latency-stringent applications may be processed at the remote cloud. Determining where the processing is to take place thus could be an important challenge and difficult to optimize. Artificial intelligence (AI) may be utilized to help resolve the issue of joint optimization. In that regard, assistance with some data from RAN 120 may be determined.

Under the third proposed scheme, distribution of MEC tasks may be assisted by the RAN. For instance, RAN 120 may signal to the MEC about assistance information (e.g., probability distribution of achievable latency (or a predefined amount of latency) and reliability as well as information about capacity) to assist the MEC in distributing its tasks. The MEC may then, based on the RAN-provided assistance information (and other information), decide to swap among the tasks of MEC rendering, split rendering, remote cloud rendering, and any other architecture.

Under a fourth proposed scheme in accordance with the present disclosure, assistance for motion prediction may be provided. The use of millimeter wave (mmWave) bands and Terahertz bands may offer an abundance of spectrum and radio resources required for AR/VR and immersive experience applications for their stringent requirements on data rates, latency and reliability. However, one main concern regarding the use of mmWave and Terahertz is the unreliability due to the extreme need for line of sight (LOS) and the high penetration loss. Many techniques to overcome this issue are available, such as the use of multiple TRPs and the development of intelligent reflectors. However, anticipation of a beam blockage event may be helpful in preparing for an action at RAN 120 to switch to a new beam or enable an intelligent reflecting surface.

Under the fourth proposed scheme, motion prediction may be used to assist RAN 120 in anticipating beam blockage events. For instance, the prediction of the motion may be via sensor(s) embedded in an AR/VR headset or any camera(s) in the surrounding environment. Alternatively, or additionally, the prediction of motion may be via MEC server 130 processing a user-viewed environment and detecting a faster change of the environment. Alternatively, or additionally, the prediction of motion may be via one or more positioning sensors.

Under a fifth proposed scheme in accordance with the present disclosure, UE 110 may report to network 120 about support of the capabilities indicated in the above-described proposed schemes by UE 110. Such capabilities may include, for example and without limitation, support of delay labeling, offloading the processing to MEC based on some criterion/criteria (e.g., remaining delay, requirements on packet delay budget (PDB) and packet error rate (PER), processing complexity, power consumption, and so on), signaling of mobility event(s) to XR server and/or MEC server, packet handling when delay budget is over, information about RAN performance (e.g., interference), and motion prediction (e.g., prediction of beam blockage). Under the fifth proposed scheme, network 120 may configure UE 110 semi-statically (e.g., via a radio resource control (RRC) signal) or dynamically (e.g., via a downlink control information (DCI) signal) to enable and/or disable one or more of the above-listed capabilities. Under the fifth proposed scheme, these capabilities may be enabled and/or disabled per application, per QoS flow, and/or per UE.

Illustrative Implementations

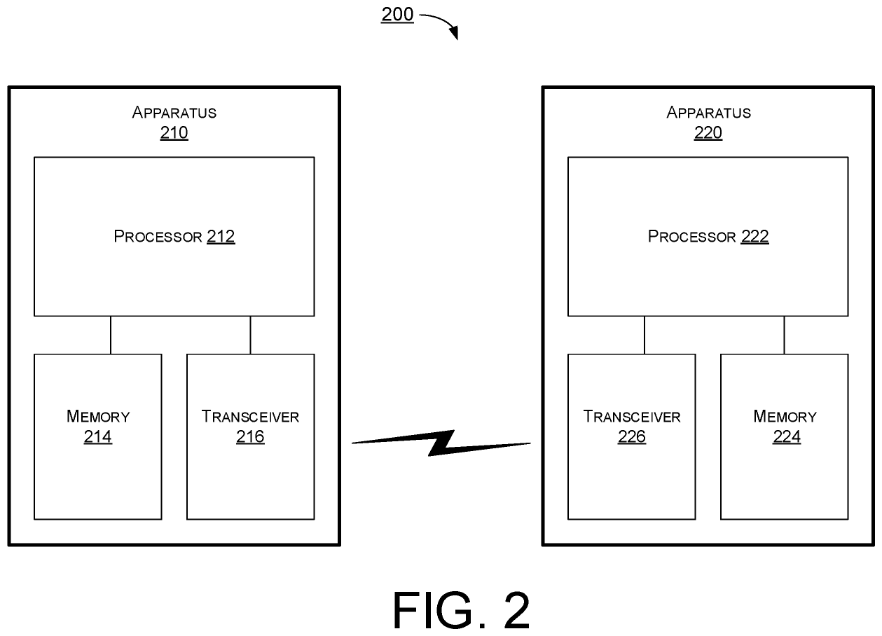

FIG. 2 illustrates an example communication system 200 having an apparatus 210 and an apparatus 220 in accordance with an implementation of the present disclosure. Each of apparatus 210 and apparatus 220 may perform various functions to implement schemes, techniques, processes and methods described herein pertaining to XR enhancement in mobile communications, including scenarios/schemes described above as well as processes described below.

Apparatus 210 may be a part of an electronic apparatus, which may be a UE (e.g., UE 110) such as a portable or mobile apparatus, a wearable apparatus, a wireless communication apparatus or a computing apparatus (e.g., MEC server 130). For instance, apparatus 210 may be implemented in a smartphone, a smartwatch, a personal digital assistant, a digital camera, or a computing equipment such as a tablet computer, a laptop computer or a notebook computer. Apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, apparatus 210 may be implemented in a smart thermostat, a smart fridge, a smart door lock, a wireless speaker or a home control center. Alternatively, apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 210 may include at least some of those components shown in FIG. 2 such as a processor 212, for example. Apparatus 210 may further include one or more other components not pertinent to the proposed scheme of the present disclosure (e.g., internal power supply, display device and/or user interface device), and, thus, such component(s) of apparatus 210 are neither shown in FIG. 2 nor described below in the interest of simplicity and brevity.

Apparatus 220 may be a part of an electronic apparatus/station, which may be a network node (e.g., network node 125) such as a base station, a small cell, a router, a gateway or a satellite. For instance, apparatus 220 may be implemented in an eNodeB in an LTE, in a gNB in a 5G, NR, IoT, NB-IoT, IIoT, or in a satellite in an NTN network. Alternatively, apparatus 220 may be implemented in the form of one or more IC chips such as, for example and without limitation, one or more single-core processors, one or more multi-core processors, or one or more RISC or CISC processors. Apparatus 220 may include at least some of those components shown in FIG. 2 such as a processor 222, for example. Apparatus 220 may further include one or more other components not pertinent to the proposed scheme of the present disclosure (e.g., internal power supply, display device and/or user interface device), and, thus, such component(s) of apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including XR enhancement in mobile communications in accordance with various implementations of the present disclosure.

In some implementations, apparatus 210 may also include a transceiver 216 coupled to processor 212 and capable of wirelessly transmitting and receiving data. In some implementations, apparatus 210 may further include a memory 214 coupled to processor 212 and capable of being accessed by processor 212 and storing data therein. In some implementations, apparatus 220 may also include a transceiver 226 coupled to processor 222 and capable of wirelessly transmitting and receiving data. In some implementations, apparatus 220 may further include a memory 224 coupled to processor 222 and capable of being accessed by processor 222 and storing data therein. Accordingly, apparatus 210 and apparatus 220 may wirelessly communicate with each other via transceiver 216 and transceiver 226, respectively.

Each of apparatus 210 and apparatus 220 may be a communication entity capable of communicating with each other using various proposed schemes in accordance with the present disclosure. To aid better understanding, the following description of the operations, functionalities and capabilities of each of apparatus 210 and apparatus 220 is provided in the context of a mobile communication environment in which apparatus 210 is implemented in or as a communication apparatus (e.g., MEC server 130) or a UE (e.g., UE 110) and apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under various proposed schemes pertaining to XR enhancement in mobile communications in accordance with the present disclosure, with apparatus 210 implemented in or as UE 110 (or MEC server 130) and apparatus 220 implemented in or as network node 125 in network environment 20, processor 212 of apparatus 210 may establish, via transceiver 216, a communication with a network node (e.g., apparatus 220 as network node 125) of a wireless network (e.g., RAN 120). Additionally, processor 212 may perform, via transceiver 216, an operation with respect to XR-related computation offloading from a user end (e.g., UE 110) to result in XR enhancement at the user end.

In some implementations, the operation may include labeling of data transmitted across one or more layers between an XR application server (e.g., MEC server 130) and the network node with delay information to assist and optimize network scheduling.

In some implementations, in labeling the data with the delay information, processor 212 may label the data with the delay information at a packet level.

In some implementations, in labeling the data with the delay information at the packet level, processor 212 may label each packet with a respective priority level corresponding to a respective amount of remaining or consumed delay.

In some implementations, the operation may further include offloading based on the labeled delay information to result in one or more packets with a smaller remaining delay budget are processed at an edge server while one or more other packets with a larger remaining delay budget are processed at a remote server.

In some implementations, in response to a respective remaining delay budget of a first packet of the one or more packets being over, in offloading, processor 212 may perform either of: (a) dropping the first packet in a current layer or at a PHY layer; or (b) adjusting a priority level of the first packet to prioritize or deprioritize the first packet.

In some implementations, in labeling the data with the delay information, processor 212 may perform packet segmentation to result in new packets sharing a same residual delay budget.

In some implementations, in labeling the data with the delay information, processor 212 may perform packet concatenation on a plurality of packets to result in new packets using a lowest delay budget among a plurality of delay budgets associated with the plurality of packets.

In some implementations, the operation may include communicating QoS metrics characterizing a network operation of the network node to an XR application server. In such cases, the QoS metrics may include a bit rate, an amount of latency and a level of reliability supported by the wireless network at a specific time.

In some implementations, the operation may include signaling to an XR application server information related to a mobility event performed by the network node to result in the XR application server using the information in sending a QoS flow, encoding, rendering adjustment, and performing codec adaptation. In some implementations, the mobility event may include a handover. Moreover, the information may indicate completion of the handover.

In some implementations, the operation may include signaling to an XR application server information on a prediction about a mobility event or a traffic-related event to result in the XR application server using the information in sending a QoS flow, encoding, rendering adjustment, and performing codec adaptation. In some implementations, the prediction about the mobility event may include prediction of a potential handover. Moreover, the prediction about the traffic-related event may include prediction of a potential user plane congestion.

In some implementations, the operation may include communicating QoS metrics characterizing an XR application server to the network node. In some implementations, the QoS metrics may include statistics including a charging data function (CDF) about delay and jitter in processing by the XR application server.

In some implementations, the operation may include signaling to an XR application server information about an event that impacts performance of the network node. In such cases, the event may include one or more of channel degradation, beam blockage, interference, and BWP switching.

In some implementations, in an event that apparatus 210 is implemented in MEC server 130, the operation may include: (a) receiving, from the network node, assistance information related to a probability distribution of achievable latency and reliability and information about capacity; and (b) based on the assistance information, distributing one or more tasks by deciding to swap among MEC rendering, split rendering, and remote cloud rendering.

In some implementations, in an event that apparatus 210 is implemented in UE 110 as a user-worn headset, the operation may include: (a) generating motion prediction information by predicting a motion based on information received from a sensor of the headset or a camera in a surrounding environment; and (b) transmitting the motion prediction information to the network node.

In some implementations, in an event that apparatus 210 is implemented in an XR application server (e.g., MEC server 130), the operation may include: (a) processing data on a user-viewed environment to detect a motion in the user-viewed environment; (b) generating motion prediction information; and (c) transmitting the motion prediction information to the network node.

Illustrative Processes

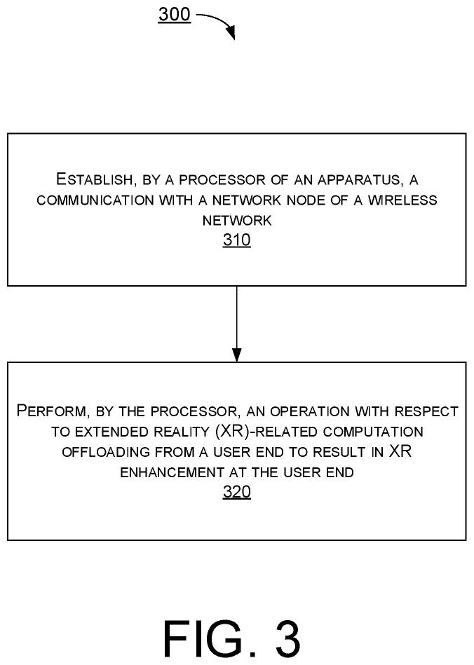

FIG. 3 illustrates an example process 300 in accordance with an implementation of the present disclosure. Process 300 may be an example implementation of schemes described above whether partially or completely, with respect to XR enhancement in mobile communications in accordance with the present disclosure. Process 300 may represent an aspect of implementation of features of apparatus 210 and apparatus 220. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by apparatus 210 or any suitable UE or machine type devices as well as by and apparatus 220 or any suitable network node or base station. Solely for illustrative purposes and without limitation, process 300 is described below in the context of apparatus 210 implemented in or as UE 110 (or MEC server 130) and apparatus 220 implemented in or as network node 125 in network environment 100. Process 300 may begin at block 310.

At 310, process 300 may involve processor 212 of apparatus 210, implemented in or as UE 110 or MEC server 130, establishing, via transceiver 216, a communication with a network node (e.g., apparatus 220 as network node 125) of a wireless network (e.g., RAN 120). Process 300 may proceed from 310 to 320.

At 320, process 300 may involve processor 212 performing, via transceiver 216, an operation with respect to XR-related computation offloading from a user end to result in XR enhancement at the user end.

In some implementations, the operation may include labeling of data transmitted across one or more layers between an XR application server (e.g., MEC server 130) and the network node with delay information to assist and optimize network scheduling.

In some implementations, in labeling the data with the delay information, process 300 may involve processor 212 labeling the data with the delay information at a packet level.

In some implementations, in labeling the data with the delay information at the packet level, process 300 may involve processor 212 labeling each packet with a respective priority level corresponding to a respective amount of remaining or consumed delay.

In some implementations, the operation may further include offloading based on the labeled delay information to result in one or more packets with a smaller remaining delay budget are processed at an edge server while one or more other packets with a larger remaining delay budget are processed at a remote server.

In some implementations, in response to a respective remaining delay budget of a first packet of the one or more packets being over, in offloading, process 300 may further involve processor 212 performing either of: (a) dropping the first packet in a current layer or at a PHY layer; or (b) adjusting a priority level of the first packet to prioritize or deprioritize the first packet.

In some implementations, in labeling the data with the delay information, process 300 may involve processor 212 performing packet segmentation to result in new packets sharing a same residual delay budget.

In some implementations, in labeling the data with the delay information, process 300 may involve processor 212 performing packet concatenation on a plurality of packets to result in new packets using a lowest delay budget among a plurality of delay budgets associated with the plurality of packets.

In some implementations, the operation may include communicating QoS metrics characterizing a network operation of the network node to an XR application server. In such cases, the QoS metrics may include a bit rate, an amount of latency and a level of reliability supported by the wireless network at a specific time.

In some implementations, the operation may include signaling to an XR application server information related to a mobility event performed by the network node to result in the XR application server using the information in sending a QoS flow, encoding, rendering adjustment, and performing codec adaptation. In some implementations, the mobility event may include a handover. Moreover, the information may indicate completion of the handover.

In some implementations, the operation may include signaling to an XR application server information on a prediction about a mobility event or a traffic-related event to result in the XR application server using the information in sending a QoS flow, encoding, rendering adjustment, and performing codec adaptation. In some implementations, the prediction about the mobility event may include prediction of a potential handover. Moreover, the prediction about the traffic-related event may include prediction of a potential user plane congestion.

In some implementations, the operation may include communicating QoS metrics characterizing an XR application server to the network node. In some implementations, the QoS metrics may include statistics including a CDF about delay and jitter in processing by the XR application server.

In some implementations, the operation may include signaling to an XR application server information about an event that impacts performance of the network node. In such cases, the event may include one or more of channel degradation, beam blockage, interference, and BWP switching.

In some implementations, in an event that apparatus 210 is implemented in MEC server 130, the operation may include: (a) receiving, from the network node, assistance information related to a probability distribution of achievable latency and reliability and information about capacity; and (b) based on the assistance information, distributing one or more tasks by deciding to swap among MEC rendering, split rendering, and remote cloud rendering.

In some implementations, in an event that apparatus 210 is implemented in UE 110 as a user-worn headset, the operation may include: (a) generating motion prediction information by predicting a motion based on information received from a sensor of the headset or a camera in a surrounding environment; and (b) transmitting the motion prediction information to the network node.

In some implementations, in an event that apparatus 210 is implemented in an XR application server (e.g., MEC server 130), the operation may include: (a) processing data on a user-viewed environment to detect a motion in the user-viewed environment; (b) generating motion prediction information; and (c) transmitting the motion prediction information to the network node.

Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a communication with a network node of a wireless network; and
performing, by the processor, an operation with respect to extended reality (XR)-related computation offloading from a user end to result in XR enhancement at the user end.

2. The method of claim 1, wherein the operation comprises labeling of data transmitted across one or more layers between an XR application server and the network node with delay information to assist and optimize network scheduling.

3. The method of claim 2, wherein the labeling of the data with the delay information comprises labeling the data with the delay information at a packet level.

4. The method of claim 3, wherein the labeling of the data with the delay information at the packet level comprises labeling each packet with a respective priority level corresponding to a respective amount of remaining or consumed delay.

5. The method of claim 2, wherein the operation further comprises offloading based on the labeled delay information to result in one or more packets with a smaller remaining delay budget are processed at an edge server while one or more other packets with a larger remaining delay budget are processed at a remote server.

6. The method of claim 5, wherein, responsive to a respective remaining delay budget of a first packet of the one or more packets being over, the offloading further comprises performing either of:
dropping the first packet in a current layer or at a physical (PHY) layer; or
adjusting a priority level of the first packet to prioritize or deprioritize the first packet.

7. The method of claim 2, wherein the labeling of the data with the delay information comprises performing packet segmentation to result in new packets sharing a same residual delay budget.

8. The method of claim 2, wherein the labeling of the data with the delay information comprises performing packet concatenation on a plurality of packets to result in new packets using a lowest delay budget among a plurality of delay budgets associated with the plurality of packets.

9. The method of claim 1, wherein the operation comprises communicating quality of service (QoS) metrics characterizing a network operation of the network node to an XR application server.

10. The method of claim 9, wherein the QoS metrics comprise a bit rate, an amount of latency and a level of reliability supported by the wireless network at a specific time.

11. The method of claim 1, wherein the operation comprises signaling to an XR application server information related to a mobility event performed by the network node to result in the XR application server using the information in sending a quality of service (QoS) flow, encoding, rendering adjustment, and performing codec adaptation.

12. The method of claim 11, wherein the mobility event comprises a handover, and wherein the information indicates completion of the handover.

13. The method of claim 1, wherein the operation comprises signaling to an XR application server information on a prediction about a mobility event or a traffic-related event to result in the XR application server using the information in sending a quality of service (QoS) flow, encoding, rendering adjustment, and performing codec adaptation.

14. The method of claim 13, wherein the prediction about the mobility event comprises prediction of a potential handover, and wherein the prediction about the traffic-related event comprises prediction of a potential user plane congestion.

15. The method of claim 1, wherein the operation comprises communicating quality of service (QoS) metrics characterizing an XR application server to the network node.

16. The method of claim 15, wherein the QoS metrics comprise statistics including a charging data function (CDF) about delay and jitter in processing by the XR application server.

17. The method of claim 1, wherein the operation comprises signaling to an XR application server information about an event that impacts performance of the network node, and wherein the event comprises one or more of channel degradation, beam blockage, interference, and bandwidth part (BWP) switching.

18. The method of claim 1, wherein, in an event that the apparatus is implemented in a multi-access edge computing (MEC) server, the operation comprises:
receiving, from the network node, assistance information related to a probability distribution of achievable latency and reliability and information about capacity; and
based on the assistance information, distributing one or more tasks by deciding to swap among MEC rendering, split rendering, and remote cloud rendering.

19. The method of claim 1, wherein, in an event that the apparatus is implemented in a user-worn headset, the operation comprises:
generating motion prediction information by predicting a motion based on information received from a sensor of the headset or a camera in a surrounding environment; and
transmitting the motion prediction information to the network node.

20. The method of claim 1, wherein, in an event that the apparatus is implemented in an XR application server, the operation comprises:
processing data on a user-viewed environment to detect a motion in the user-viewed environment;
generating motion prediction information; and
transmitting the motion prediction information to the network node.
